(19) United States
(12) Patent Application Publication
(10) Pub. No.: US 2025/0190212 A1
(43) Pub. Date: Jun. 12, 2025

(54) MACHINE LEARNING ALGORITHM RECOMMENDATION

(71) Applicant: Dell Products L.P., Round Rock, TX (US)

(72) Inventors: Bijan Kumar Mohanty, Austin, TX (US); Shamik Kacker, Austin, TX (US); Thiagarajan Ramakrishnan, Round Rock, TX (US); Hung Dinh, Austin, TX (US)

(21) Appl. No.: 18/531,897

(22) Filed: Dec. 7, 2023

(51) Int. Cl. G06F 8/71

(52) U.S. Cl. CPC G06F 8/71

(57) ABSTRACT

A method comprises receiving a request to predict at least one machine learning algorithm to perform one or more tasks and to predict a configuration of one or more workspaces in which the at least one machine learning algorithm is to be executed. Using the one or more machine learning models, the at least one machine learning algorithm and the configuration of the one or more workspaces are predicted in response to the request. The one or more workspaces are configured based, at least in part, on the predicted configuration.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to machine learning algorithm recommendation.

### BACKGROUND

Machine learning (ML) is growing rapidly across many industries, and the number of available machine learning algorithms to perform various operations is increasing. The selection of a machine algorithm to perform a given operation is a complex process that is influenced by multiple factors such as, for example, the type of predictions to be made, data needed for training and other factors. Current approaches for identifying which machine learning algorithms to use require multiple steps that consume large amounts of compute resources. For example, the selection process requires performance of multiple iterations of data engineering, data visualization, training, testing and validation processes with different algorithms before a selection is made. Moreover, the selection process must be repeated each time a new machine learning algorithm is needed.

### SUMMARY

Embodiments provide a machine learning algorithm recommendation platform in an information processing system.

For example, in one embodiment, a method comprises receiving a request to predict at least one machine learning algorithm to perform one or more tasks and to predict a configuration of one or more workspaces in which the at least one machine learning algorithm is to be executed. Using the one or more machine learning models, the at least one machine learning algorithm and the configuration of the one or more workspaces are predicted in response to the request. The one or more workspaces are configured based, at least in part, on the predicted configuration.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a machine learning algorithm recommendation platform in an illustrative embodiment.

FIG. 2 depicts an operational flow for machine learning algorithm recommendation and workspace assignment in an illustrative embodiment.

FIG. 3 depicts an operational flow for prediction of machine learning algorithm type and of a corresponding workspace configuration in an illustrative embodiment.

FIG. 4 depicts example training data in an illustrative embodiment.

FIG. 5 depicts an architecture of a neural network used for prediction of machine learning algorithm type and of a corresponding workspace configuration in an illustrative embodiment.

FIG. 6 depicts example pseudocode for importation of libraries in an illustrative embodiment.

FIG. 7 depicts example pseudocode for loading historical machine learning workspace metrics data into a data frame in an illustrative embodiment.

FIG. 8 depicts example pseudocode for encoding training data in an illustrative embodiment.

FIG. 9 depicts example pseudocode for splitting a dataset into training and testing components and for creating separate datasets for independent and dependent variables in an illustrative embodiment.

FIG. 10 depicts example pseudocode for building a neural network in an illustrative embodiment.

FIG. 11 depicts example pseudocode for compiling and training the neural network in an illustrative embodiment.

FIG. 12 depicts example pseudocode for predicting target values using the neural network in an illustrative embodiment.

FIG. 13 depicts a process for machine learning algorithm recommendation according to an illustrative embodiment.

FIGS. 14 and 15 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a user device receives messages without any significant time delay. Of course, it should be understood that depending on the particular temporal nature of the system in which an embodiment is implemented, other appropriate timescales that provide at least contemporaneous performance and output can be achieved.

As used herein, “application programming interface (API)” or “interface” refers to a set of subroutine definitions, protocols, and/or tools for building software. Generally, an API defines communication between software components. APIs permit programmers to write software applications consistent with an operating environment or website. APIs are used to integrate and pass data between applications, and may be implemented on top of other systems.

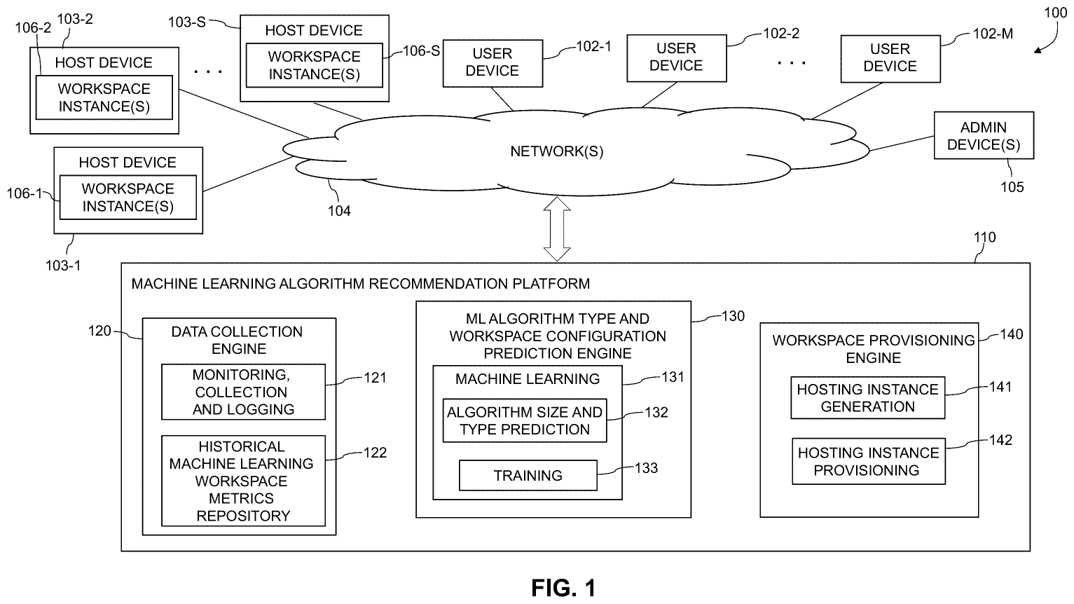

FIG. 1 shows an information processing system 100 configured in accordance with an illustrative embodiment. The information processing system 100 comprises user devices 102-1, 102-2, . . . 102-M (collectively “user devices 102”), host devices 103-1, 103-2, . . . 103-S (collectively “host devices 103”), and one or more administrator devices (“Admin device(s)”) 105. The user devices 102, host devices 103 and administrator devices 105 communicate over a network 104 with a machine learning algorithm recommendation platform 110. The variable M and other similar index variables herein such as K, L and S are assumed to be arbitrary positive integers greater than or equal to one.

The user devices 102, host devices 103 and administrator devices 105 can comprise, for example, Internet of Things (IoT) devices, desktop, laptop or tablet computers, mobile telephones, or other types of processing devices capable of communicating with the machine learning algorithm recommendation platform 110 over the network 104. Such devices are examples of what are more generally referred to herein as “processing devices.” Some of these processing devices are also generally referred to herein as “computers.” The user devices 102, host devices 103 and administrator devices 105 may also or alternately comprise virtualized computing resources, such as virtual machines (VMs), containers, etc. The user devices 102, host devices 103 and/or administrator devices 105 in some embodiments comprise respective computers associated with a particular company, organization or other enterprise.

The terms “user” or “administrator” herein are intended to be broadly construed so as to encompass numerous arrangements of human, hardware, software or firmware entities, as well as combinations of such entities. Resource prediction services may be provided for users utilizing one or more machine learning models, although it is to be appreciated that other types of infrastructure arrangements could be used. At least a portion of the available services and functionalities provided by the machine learning algorithm recommendation platform 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the machine learning algorithm recommendation platform 110, as well as to support communication between the machine learning algorithm recommendation platform 110 and connected devices (e.g., user devices 102, host devices 103 and administrator devices 105) and/or other related systems and devices not explicitly shown.

In some embodiments, the administrator devices 105 are assumed to be associated with repair technicians, system administrators, information technology (IT) managers, software developers, release management personnel or other authorized personnel configured to access and utilize the machine learning algorithm recommendation platform 110.

As explained in more detail herein, the host devices 103 comprise respective workspace instance(s) 106-1, 106-2, . . . 106-S (collectively “workspace instances 106”). A host device 103 may comprise one or more workspace instances 106 configured to execute machine learning algorithms and corresponding tasks. For example, a plurality of workspace instances 106 respectively corresponding to different workspaces may collectively correspond to services associated with execution of a machine learning algorithm, with each workspace instance corresponding to an independently deployable service associated with the execution of the machine learning algorithm. In illustrative embodiments, each function or a plurality of functions of a machine learning application are executed by an autonomous, independently-running workspace. As explained in more detail herein, a workspace may run in a container (e.g., Docker, Linux container (LXC) or other type of container), virtual machine (VM) and/or pod on a host device (e.g., host device 103). As used herein, a “pod” refers to a group of one or more containers. The containers in a pod may share storage network resources and a specification for how to run the containers.

Different instances of the same workspace may run in different containers on the same host device or on different host devices 103. The host devices 103 may be, for example, cloud servers. Respective workspaces may correspond to one or more machine learning functions such as, but not necessarily limited to, training, testing, regression, classification, naturals language processing (NLP), image classification, etc. The workspaces may be loosely integrated with each other using API gateways. Container orchestration tools such as, for example, Kubernetes®, can be utilized to manage the allocation of system resources for each workspace.

Workspaces may be deployed in a container-based environment for fault tolerance and resiliency and may be managed by container orchestration tools such as, for example, Kubernetes®, Docker Swarm®, AmazonEKS® (Elastic Kubernetes Service), AmazonECS® (Elastic Container Service), and PKS® (Pivotal Container Service). These orchestration tools may support dynamic automatic scaling (also referred to herein as “elastic auto-scaling”) of a container cluster to automatically scale a workspace's infrastructure in an effort to meet demands associated with configuring a workspace based on predicted resource sizes in connection with the execution of a recommended machine learning algorithm for a given task. Similarly, automatic scaling of VMs can be supported in cloud environments such as, for example, Amazon® Web Services (AWS®), Azure® and VMWare Tanzu®.

As noted herein above, the selection of a machine algorithm to perform a given operation is a complex process that is influenced by multiple factors such as, for example, the type of predictions to be made, data needed for training and other factors. Conventional approaches for identifying which machine learning algorithms to use require multiple steps that consume large amounts of compute resources. For example, tasks such as forecasting sales, predicting buying habits, estimating manufacturing time and detecting fraudulent transactions are all different from each other. Different types of machine algorithms and corresponding resource configurations are needed to perform the different tasks. As can be understood, the different machine algorithms may utilize different techniques including, but not necessarily limited to, supervised learning, unsupervised learning, reinforcement learning, shallow learning and/or deep learning. In addition, some tasks may further require NLP, image analysis and/or computer vision techniques.

With conventional approaches, the evaluation of machine learning algorithm candidates requires large amounts of compute resources to perform, for example, data engineering, data visualization, training, testing and cross validation. Hyperparameter tuning and computation of, for example, accuracy, recall, precision and/or f1 scores is further performed when determining whether a proposed machine learning algorithm is suitable for a given task. The complex evaluation process must be repeated each time a proposed machine learning algorithm is evaluated and/or a new objective requiring machine learning is developed.

Advantageously, illustrative embodiments provide techniques for using machine learning to predict which machine learning algorithm to use for a given task, along with a corresponding configuration of various resources that will be needed for execution of the predicted machine learning algorithm. By leveraging historical data related to the previous execution of machine learning products and their corresponding workspaces, and training a multi-target classification and regression machine learning model with historical machine learning workspace metrics, illustrative embodiments provide techniques to predict an appropriate machine learning algorithm for a given objective, as well as a configuration of one or more workspaces in which the predicted machine learning algorithm can be implemented. The configuration includes elements such as, for example, a number of containers (or other required host instances) and resource sizes (e.g., compute, ephemeral storage, and other resource sizes) of one or more workspaces. Advantageously, the predicted configuration and machine learning algorithm are used by a workspace provisioning tool to provision one or more workspaces in which the machine learning algorithm can be executed.

The machine learning algorithm recommendation platform 110 in the present embodiment is assumed to be accessible to the user devices 102, host devices 103 and/or administrator devices 105 and vice versa over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Referring to FIG. 1, the machine learning algorithm recommendation platform 110 includes a data collection engine 120, a machine learning (ML) algorithm type and workspace configuration prediction engine 130 and a workspace provisioning engine 140. The data collection engine 120 includes a monitoring, collection and logging layer 121 and a historical machine learning workspace metrics repository 122. The ML algorithm type and workspace configuration prediction engine 130 includes a machine learning layer 131 comprising algorithm size and type prediction and training layers 132 and 133. The workspace provisioning engine 140 includes a hosting instance generation layer 141 and a hosting instance provisioning layer 142.

The monitoring, collection and logging layer 121 of the data collection engine 120 collects workspace metrics data corresponding to processing by the workspace instances 106 of operations associated with the execution of machine learning algorithms. The workspace metrics data may be collected from the host devices 103 and/or from applications used for monitoring workspace and host component metrics, such as, for example, Kubernetes®, Docker Swarm®, AmazonEKS®, AmazonECS®, PKS® and other container orchestration or monitoring tools. The workspace metrics data comprises, for example, for respective ones of a plurality of workspaces, workspace identifiers (e.g., workspace names), the type of machine learning operations executed in a given workspace (c.g., regression, classification, NLP, image classification, recommendation, etc.), the type of machine learning algorithm used in a given workspace, the type of domain (e.g., enterprise domains such as, but not necessarily limited to, support, sales, marketing, supply chain) to which the workspace corresponds, machine learning training dataset size for a given workspace, feature dimension size for a given workspace, a number of users associated with the task for which machine learning is being implemented and usage type (e.g., production or non-production in a given enterprise) corresponding to an objective for a machine learning algorithm implemented in a given workspace. The workspace metrics data further comprises, for example, hosting instance identifiers (e.g., container, pod and/or VM IDs), a number of hosting instances (e.g., containers, pods, VMs), an amount of central processing unit (CPU) utilization (e.g., number of CPU cores (millicores)), an amount of memory utilization and an amount of input/output (IO) utilization for respective ones of a plurality of workspaces. Memory utilization amounts can include, for example, amounts of ephemeral storage in a given hosting instance or workspace and/or amounts of random access memory (RAM) associated with a given hosting instance or workspace. In illustrative embodiments, the workspace metrics data comprises average CPU, memory and IO utilization values of a workspace.

The monitoring, collection and logging layer 121 collects historical workspace metrics data corresponding to processing by the workspace instances 106 of operations associated with the execution of machine learning algorithms. The collected data comprises past workspace metrics data corresponding to workspace operations which have been completed. The historical workspace metrics data may be collected from the host devices 103 and/or from applications (e.g., cloud-based applications) used for monitoring workspace and host instance metrics, such as, for example, the container orchestration or monitoring tools mentioned herein above, which log workspace, host instance and application activity. The historical workspace metrics data is stored in the historical machine learning workspace metrics repository 122 and input to the ML algorithm type and workspace configuration prediction engine 130 to be used as training data by the training layer 133. The historical workspace metrics data is used to train the machine learning models used by the algorithm size and type prediction layer 132 to learn different combinations of metrics that correspond to particular machine learning algorithms and resource configurations.

The ML algorithm type and workspace configuration prediction engine 130, more particularly, the training layer 133 of the machine learning layer 131 uses the historical workspace metrics data collected by the monitoring, collection and logging layer 121 to train one or more machine learning algorithms used by the algorithm size and type prediction layer 132 to predict a machine learning algorithm to perform one or more tasks and to predict a configuration of one or more workspaces in which the predicted machine learning algorithm is to be executed. In accordance with one or more embodiments, in response to a request to predict a machine learning algorithm and a corresponding workspace configuration received from a user via the workspace provisioning engine 140, the algorithm size and type prediction layer 132 predicts a best fit machine learning algorithm and an optimal configuration of a machine learning workspace based on a variety of features specified in the request. The features specified in the request include, for example, information regarding the type of machine learning needed (e.g., regression, classification, NLP, image classification, recommendation, etc.), required or desired size of a training dataset, required or desired feature dimension size, domain type, a number of users working with or accessing the workspace, and a type of usage (e.g., production/non-production).

The predicted workspace configuration including, for example, resource size information, is used by the workspace provisioning engine 140, more particularly, the hosting instance generation layer 141, to create the hosting instance with corresponding resource allocations in which the predicted machine learning algorithm is to be executed. The workspace provisioning engine 140 (more particularly, the hosting instance provisioning layer 142), which may comprise, but is not necessarily limited to, infrastructure orchestration tools like Kubernetes®, Docker Swarm®, AmazonEKS®, AmazonECS® and PKS®, applies the predicted workspace configuration when provisioning new instances of containers, pods and/or VMs.

In illustrative embodiments, the algorithm size and type prediction layer 132 uses the multi-target (also referred to herein as “multi-output”) classification and regression machine learning algorithm to predict machine learning algorithm type and workspace configuration including, for example, a number of hosting instances (e.g., pods, containers and/or VMs) and a size of one or more resources one or more workspaces. The sizes of various resources include, but are not necessarily limited to, CPU utilization, memory utilization (e.g., ephemeral storage and/or RAM) and other resource utilization in a hosting instance. In illustrative embodiments, the machine learning algorithm is predicted by the classification portion of the algorithm and the workspace configuration is predicted by the regression portion of the algorithm. Historical machine learning workspace metrics are received by the algorithm size and type prediction layer 132 from the historical machine learning workspace metrics repository 122.

The machine learning layer 131 uses a supervised learning approach to leverage the multi-target classification and regression machine learning algorithm to predict machine learning algorithm type and workspace configuration. Historical machine learning workspace metrics including hosting infrastructure data (e.g., for containers, host devices, etc.) can be harvested by the monitoring, collection and logging layer 121 from monitoring and logging systems associated with the host devices 103 and/or in the cloud. As explained in more detail, herein the historical machine learning workspace metrics data is used by the training layer 133 to train the machine models used in the algorithm size and type prediction layer 132.

The multi-target classification and regression machine learning algorithm uses one or more independent variables to predict multiple dependent variable outputs (e.g., machine learning algorithm type, a number of containers (or other host instances), CPU utilization and memory utilization for respective ones of a plurality of workspaces). The outputs may be dependent on the input(s) and upon each other. For example, the number of containers and/or memory utilization may be dependent upon the CPU utilization and vice versa. The outputs are not necessarily independent of each other and may require a model that predicts outputs together or each output contingent upon other outputs.

Illustrative embodiments may use different approaches and algorithms to achieve multi-target classification and regression. Some algorithms have built-in support for multiple outputs. In some embodiments, algorithms that do not have built-in support for multi-target classification and regression use a wrapper to achieve multi-output support. The embodiments utilize, for example, linear regression/classification, KNN regression/classification and/or random forest regression/classification algorithms, which natively support multi-target predictions. Some embodiments utilize, for example, support vector machine (SVM) regression/classification or gradient boosting regression/classification algorithms that do not natively support multi-target predictions. In this case, these algorithms are used in conjunction with a wrapper function (e.g., MultiOutputRegressor/MultiOutputClassifier, available from a multi-output package of an ScikitLearn library). Instances of the unsupported algorithms are input to the wrapper function to create a model that is capable of predicting multiple output values.

Due to the complexity and dimensionality of the data as well as the nature of multi-target prediction and estimation, illustrative embodiments leverage a deep neural network and, in a non-limiting operational example, generate a custom neural network that has four parallel branches, where one branch functions as a classifier (for predicting the machine learning algorithm) and the remaining three branches function as regressors (for predicting the number of containers, CPU size and memory size of each container). While this operational example utilizes four parallel branches, the embodiments are not necessarily limited thereto, and more or less than four branches may be used depending on the number of regressors that may be needed to predict configurations of different types of resources in a workspace.

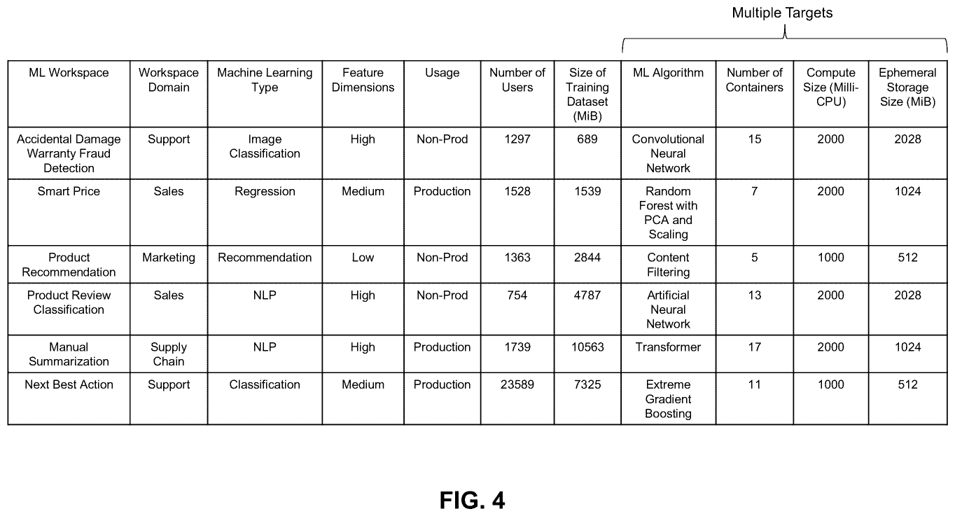

As noted herein, historical machine learning workspace metrics are used for training the multi-target classification and regression models. FIG. 4 depicts example training data in an illustrative embodiment. As can be seen in the table 400, the training data identifies the machine learning workspace name, the workspace domain (e.g., support, sales, marketing, supply chain), machine learning type (e.g., image classification, regression, recommendation, NLP, classification), size of feature dimensions (e.g., low, medium, high), usage (e.g., production, non-production) and size of training datasets (e.g., MiB). The training data further includes four possible ones of the multiple outputs including, but not necessarily limited to, machine learning algorithm, number of containers, compute size (e.g., number of CPU cores (millicores)) and ephemeral storage size of host components (e.g., host devices, containers, pods, VMs, etc.) (e.g., MiB). The data shown in the table 400 is a non-limiting example of the attributes of training data, and the embodiments are not necessarily limited to the depicted attributes.

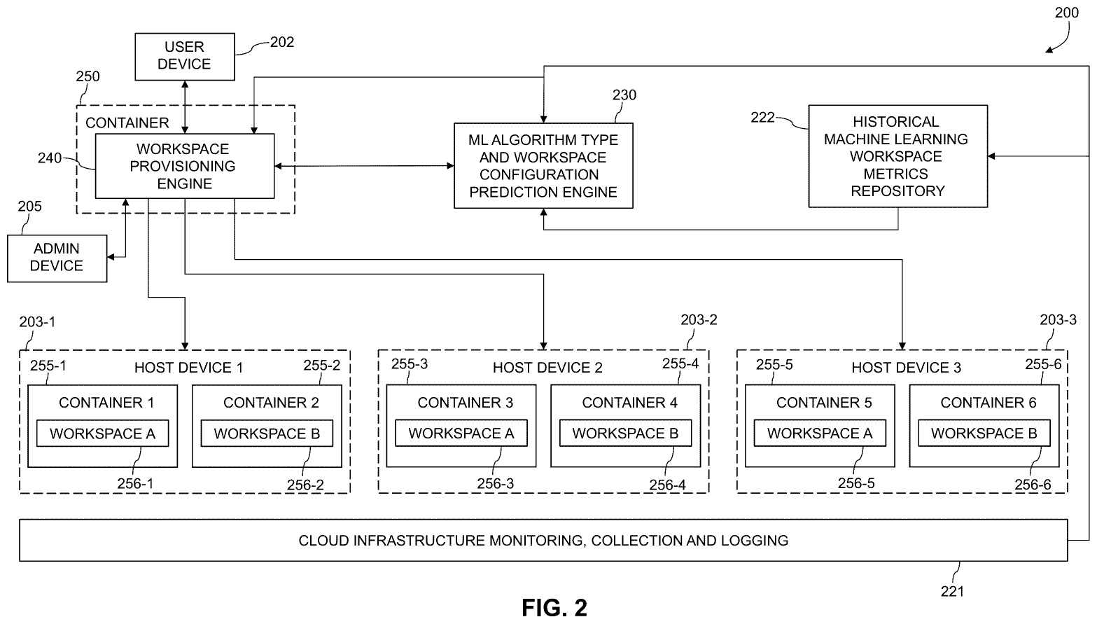

Referring to the operational flow 200 in FIG. 2, the cloud infrastructure monitoring, collection and logging layer 221, which is the same as or similar to the monitoring, collection and logging layer 121, monitors, collects and logs past and current workspace operation and host component parameters as described hereinabove. The past workspace operation and host component parameter data is sent to the historical machine learning workspace metrics repository 222 (which is the same as or similar to the historical machine learning workspace metrics repository 122) and is provided to the ML algorithm type and workspace configuration prediction engine 230 as training data. The ML algorithm type and workspace configuration prediction engine 230 is the same as or similar to the ML algorithm type and workspace configuration prediction engine 130.

The cloud infrastructure monitoring, collection and logging layer 221 monitors, collects and logs past and current metrics corresponding to processing by workspace instances of operations associated with the execution of machine learning algorithms. The metrics may be collected from host device 1 203-1, host device 2 203-2 and host device 3 203-3 (collectively “host devices 203”), which can be the same as or similar to the host devices 103. Host device 1 203-1 comprises container 1 255-1 and container 2 255-2 respectively hosting instances of workspace A 256-1 and workspace B 256-2. Host device 2 203-2 comprises container 3 255-3 and container 4 255-4 respectively hosting additional instances of workspace A 256-3 and workspace B 256-4. Host device 3 203-2 comprises container 5 255-5 and container 6 255-6 respectively hosting further instances of workspace A 256-5 and workspace B 256-6. Although three host devices 203 each comprising two containers 255 and two workspace instances 256 are shown, the embodiments are not necessarily limited thereto. For example, there may be more or less than three host devices 203, and the number of containers 255 and workspace instances 256 in each host device 203 can vary. Workspaces A and B are different workspaces (e.g., perform different functions). Different instances of workspace A in different containers correspond to the same workspace (e.g., perform the same function). Different instances of workspace B in different containers correspond to the same workspace (e.g., perform the same function).

The workspace provisioning engine 240 is the same as or similar to the workspace provisioning engine 140. In illustrative embodiments, the workspace provisioning engine 240 is hosted in container 250 (e.g., Docker, LXC or other type of container) and acts as a router for provisioning workspaces to the appropriate containers 255. The operational flow 200 further depicts a user device 202, which may be the same as or similar to one of the user devices 102 and an administrator device (“Admin device”) 205, which may be the same as or similar to one of the Admin device(s) 105. In illustrative embodiments, in response to a request for a machine learning algorithm and corresponding workspace received by the workspace provisioning engine 240 from one or more users (e.g., via user device 202), the workspace provisioning engine 240 forwards the request to the ML algorithm type and workspace configuration prediction engine 230. In illustrative embodiments, the request comprises a request to predict a machine learning algorithm and corresponding workspace, along with one or more features associated with the execution of a machine learning algorithm in a workspace. The request may be generated at least in part by calling an API and/or sending the features in a JavaScript Object Notation (JSON) format. The features include, for example, the type of machine learning needed (e.g., regression, classification, NLP, image classification, recommendation, etc.), required or desired size of a training dataset, required or desired feature dimension size, domain type, a number of users working with or accessing the workspace, and a type of usage (e.g., production/non-production).

Using one or more machine learning models, in response to the request, the ML algorithm type and workspace configuration prediction engine 230 predicts a machine learning algorithm and values for one or more workspaces including, for example, the number of containers, an amount of compute resources and an amount of memory resources needed in each container to host the predicted algorithm. In an illustrative embodiment, the predicted resource amounts (e.g., CPU millicores and memory sizes) are provided to the workspace provisioning engine 240, which generates and provisions new hosting instances incorporating the predicted resource amounts. For example, as shown in FIG. 2, in a scenario where containers for workspaces A and B are needed, the workspace provisioning engine 240 predicts resource sizes for containers hosting workspaces A and B and, generates containers 1 to 6 255-1 to 255-6 with predicted resource sizes for instances of workspaces A and B 256-1 to 256-6. In more detail, a hosting instance generation layer in workspace provisioning engine 240 (similar to hosting instance generation layer 141) generates containers 1 to 6 255-1 to 255-6 based on the predicted resource sizes. A hosting instance provisioning layer in workspace provisioning engine 240 (similar to hosting instance provisioning layer 142) provisions instances of workspaces A and B 256-1 to 256-6 to containers 1 to 6 255-1 to 255-6. In one or more embodiments, the host devices 203 (or 103) and the containers 255 may be part of a cluster of host devices 203 (or 103) and/or containers 255.

In an illustrative embodiment, after predicting a machine learning algorithm and corresponding configuration of one or more workspaces, an optional step of requesting approval by a platform administrator (e.g., via admin device 105/205) and/or a customer (e.g., via user device 102/202) can be implemented. For example, an approval request can be generated by the workspace provisioning engine 140/240 and transmitted to the admin device 105/205 and/or user device 102/202. Upon receipt of approval by the workspace provisioning engine 140/240 from the admin device 105/205 and/or user device 102/202, the workspace provisioning engine 140/240 (more particularly the hosting instance provisioning layer 142) uses, for example, Kubernetes functions (e.g., calls necessary APIs) to provision one or more workspaces in a predicted number of required containers and to provision predicted resource sizes in a shared platform, as well as install the appropriate libraries to work with the predicted machine learning algorithm. Once the workspaces are provisioned, customers or other users can be notified of the type of the predicted machine learning algorithm and the necessary libraries needed for its implementation.

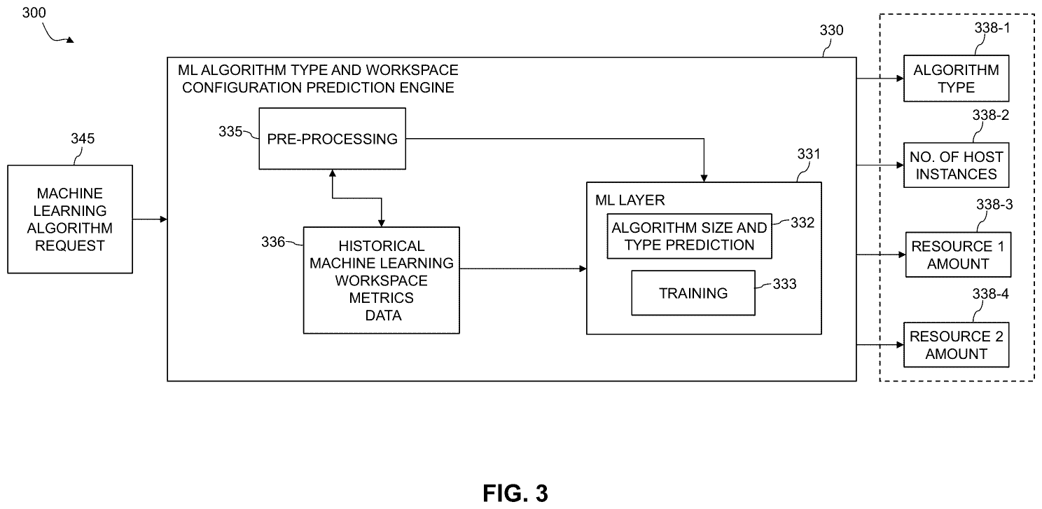

Referring to the operational flow 300 in FIG. 3, a more detailed explanation of an embodiment of a ML algorithm type and workspace configuration prediction engine 330 is described. The ML algorithm type and workspace configuration prediction engine 330 may be the same as or similar to the ML algorithm type and workspace configuration prediction engine 130 or 230. A machine learning algorithm request 345 the same or similar to a request for a machine learning algorithm and corresponding workspace described in connection with FIG. 2 is received from, for example, a workspace provisioning engine (e.g., workspace provisioning engine 140 or 240) and input to the ML algorithm type and workspace configuration prediction engine 330. The ML algorithm type and workspace configuration prediction engine 330 illustrates a pre-processing component 335, which processes the incoming request and the historical machine learning workspace metrics data 336 for analysis by the machine learning (ML) layer 331. For example, the pre-processing component 335 removes any unwanted characters, punctuation, and stop words. The pre-processing component 335 performs data engineering and data pre-processing to isolate features and data elements that will be influencing the machine learning algorithm and workspace configuration predictions. In illustrative embodiments, the data engineering and data pre-processing includes generation of multivariate plots and/or correlation heatmaps to identify the significance of each feature in the dataset so that less important data elements are filtered (e.g., removed or assigned less weight). As a result, the dimensions and complexity of the model are reduced, hence improving accuracy and performance of the model.

As can be seen in FIG. 3, the ML algorithm type and workspace configuration prediction engine 330 predicts a machine learning algorithm and corresponding workspace using the ML layer 331 comprising algorithm size and type prediction and training layers 332 and 333. The ML layer 331 is the same as or similar to machine learning layer 131. In illustrative embodiments, the algorithm size and type prediction layer 332 determines, based on the historical machine learning workspace metrics data 336 collected by a monitoring, collection and logging layer (e.g., monitoring, collection and logging layer 121 or 221), machine learning algorithm type 338-1, a number of hosting instances (e.g., containers, pods, VMs) 338-2 for one or more workspaces, and resource 1 and 2 amounts 338-3 and 338-4 for the one or more containers and/or the one or more workspaces. According to one or more embodiments, the resource 1 and resource 2 amounts 338-3 and 338-4 correspond to CPU millicores and memory size (e.g., RAM and/or ephemeral storage).

In an illustrative embodiment, the ML layer 331 utilizes a multi-output neural network comprising a deep neural network that has four parallel branches the four outputs 338-1, 338-2, 338-3 and 338-4. By taking the same set of input variables as a single input layer and building a dense multi-layer neural network, ML layer 331 functions as a sophisticated parallel classifier and regressor for multi-output predictions.

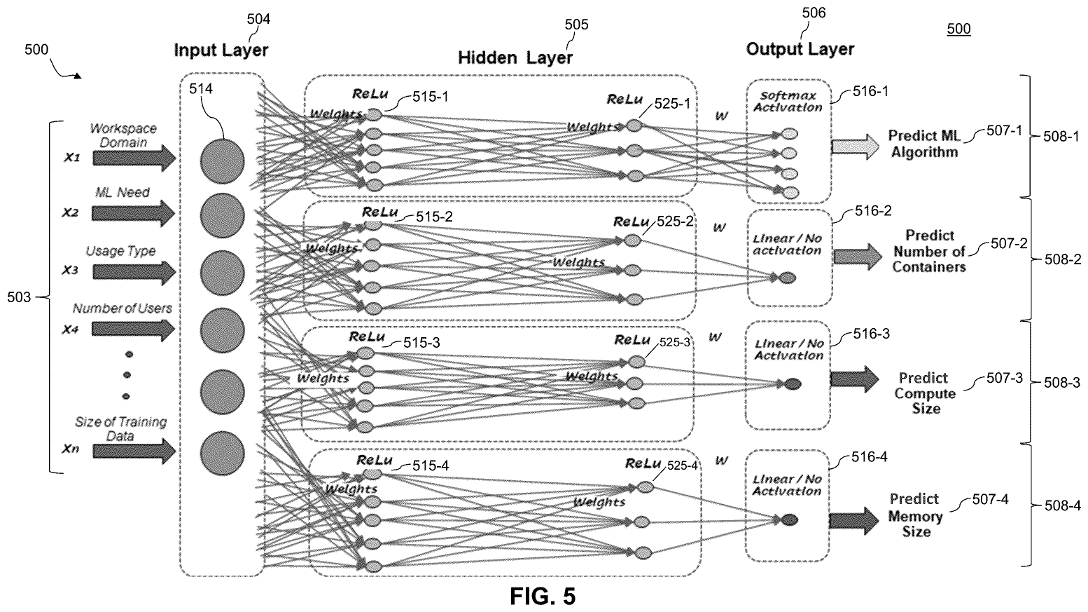

Referring to FIG. 5, an illustrative neural network 500 that can be used by the ML layer 331 comprises an input layer 504, one or more (in this case 2) hidden layers 505 and an output layer 506. As a multi-output neural network, four separate branches 508-1, 508-2, 508-3 and 508-4 are components of the hidden layers 505 and output layer 506. Each of the branches connect to the input layer 504. Input layer 504 comprises a plurality of neurons 514 that matches the number of input/independent variables 503. The number of input/independent variables 503 may be specified in a request (e.g., machine learning algorithm request 345) and include, but are not necessarily limited to, X1 workspace domain, X2 machine learning need (e.g., classification, regression, NLP, etc.), X3 usage type, X4 number of users, . . . , Xn size of training data.

Hidden layer 505 includes 2 layers for each of the branches 508, respective ones of the two layers in each branch 508-1, 508-2, 508-3 and 508-4 (collectively, “branches 508”) comprising first neurons 515-1, 515-2, 515-3 and 515-4 (collectively, “first neurons 515”) and second neurons 525-1, 525-2, 525-3 and 525-4 (collectively, “second neurons 525”). The number of first and second neurons 515 and 525 in each hidden layer depends upon the number of neurons 514 in the input layer. The output layer for first branch 508-1 can contain a different number of neurons 516-1 (e.g., one neuron for each type of algorithm class) than the number of neurons 516-2, 516-3 and 516-4 in the remaining branches 508-2, 508-3 and 508-4. For example, the remaining three branches 508-2, 508-3 and 508-4 each include one neuron 516-2, 516-3 and 516-4. First branch 508-1 is configured as a multi-class classifier with multiple neurons 516-1 using Softmax activation to output a predicted machine learning algorithm 507-1. The remaining three branches 508-2, 508-3 and 508-4 are configured as regressor branches, with one neuron each (516-2, 516-3 and 516-4) for the output layer 506, using a linear or no activation function to respectively output a predicted number of containers 507-2, a predicted compute size 507-3 and a predicted memory size 507-4. The neurons 515 and 525 in the hidden layers 505 use a rectified linear unit (ReLu) activation function for all four branches 508. An activation function determines whether a neuron will fire or not fire. The neural network 500 assumes that there are 4 types of machine learning algorithms (hence four neurons 516-1), but the embodiments are not necessarily limited thereto.

In the illustrative embodiment of FIG. 5, each of the neurons 514 connects with each of the neurons 515, and in a given branch 508, each of the neurons 515 connects with each of the neurons 525, and each of the neurons 525 connects with the neurons 516. For example, in a given branch 508-1, each of the neurons 515-1 connects with each of the neurons 525-1, and each of the neurons 525-1 connects with the neurons 516-1. Each connection has a weight factor.

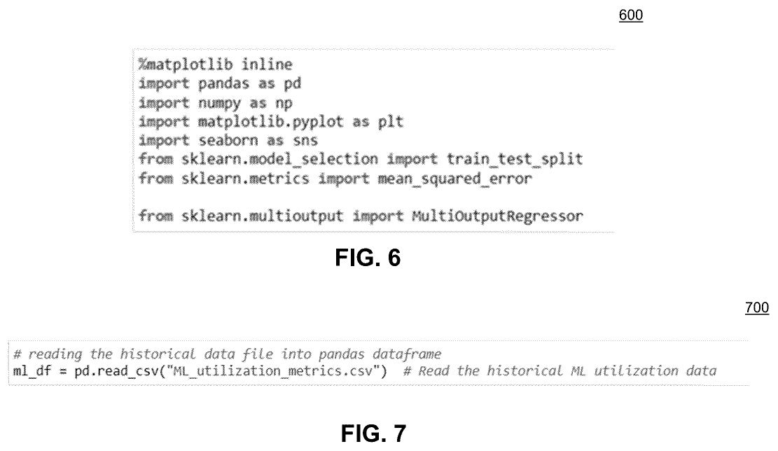

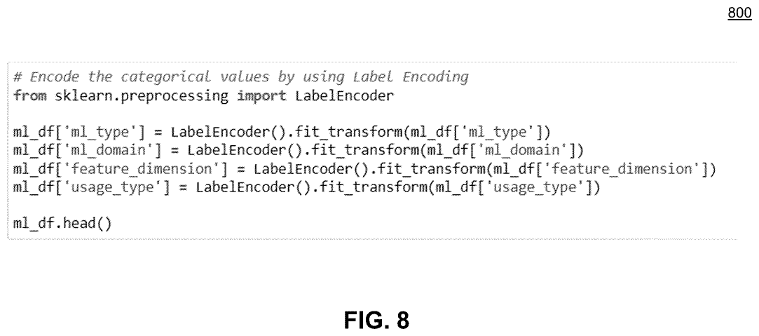

In connection with the operation of the ML algorithm type and workspace configuration prediction engine 330 (or 130/230), FIG. 6 depicts example pseudocode 600 for importation of libraries used to implement the ML algorithm type and workspace configuration prediction engine 330. For example, Python, ScikitLearn, Pandas and Numpy libraries can be used. Some embodiments may implement multi-output classification and regression using a neural network with Tensorflow® and/or Keras libraries. FIG. 7 depicts example pseudocode 700 for loading historical machine learning workspace metrics data into a Pandas data frame for building training data.

In more detail, the historical machine learning workspace metrics data 336 is read and a Pandas data frame is generated, which contains all the columns including independent variables and the dependent/target variable columns (e.g., four columns representing ML algorithm, number of containers, compute size and memory size). The pre-processing component 335 performs pre-processing of data to handle any null or missing values in the columns. For example, null/missing values in numerical columns can be replaced by the median value of that column. After performing initial data analysis by creating univariate and bivariate plots of these columns, the importance and influence of each column can be understood. Columns that have no role or influence on the actual prediction (target variable) can be dropped.

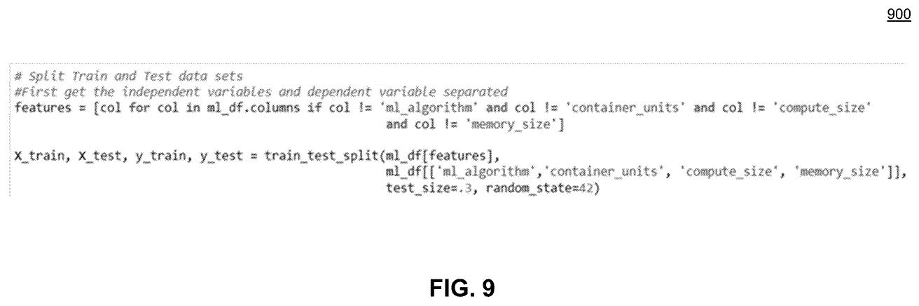

Since machine learning works with numbers, categorical and textual attributes like machine learning type, domain name, usage type, etc. must be encoded before being used as training data. In one or more embodiments, the pre-processing component 335 leverages a LabelEncoder function of ScikitLearn library as shown in the pseudocode 800 in FIG. 8.

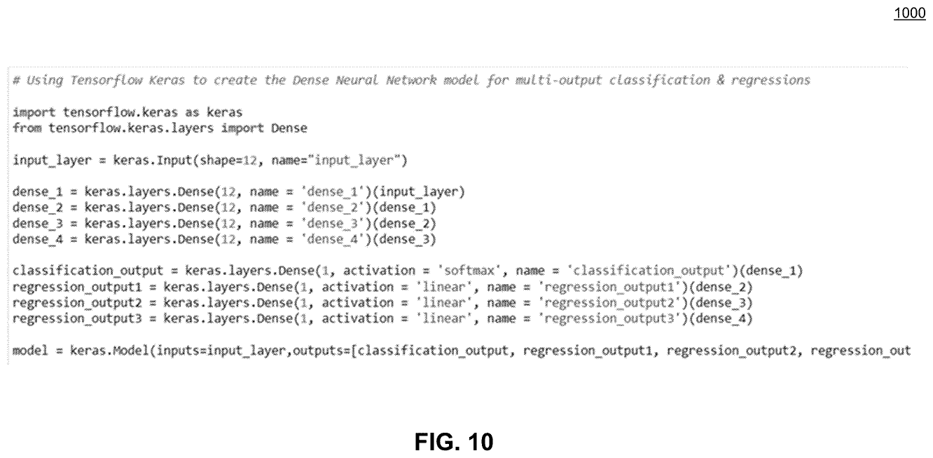

According to illustrative embodiments, the encoded training dataset is split into training and testing datasets, separate datasets are created for independent variables and dependent variables. For example, some embodiments use four dependent variables (e.g., machine learning algorithm type, a number of containers, CPU utilization and memory utilization). FIG. 9 depicts example pseudocode 900 for splitting a dataset into training and testing components and for creating separate datasets for independent (X) and dependent (y) variables.

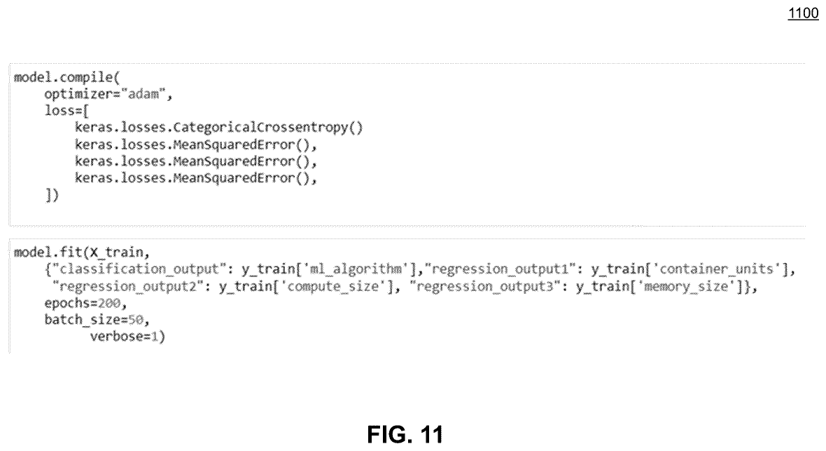

In some illustrative embodiments, a multi-layer and multi-output dense neural network is built to predict multiple target variables (e.g., machine learning algorithm type, a number of containers, CPU utilization and memory utilization). For example, referring to FIG. 10, which depicts example pseudocode 1000 for building a neural network, a dense neural network is built using a Keras functional model. Four separate dense layers are added to the input layer with each network being capable of predicting a target (e.g., machine learning algorithm type, a number of containers, CPU utilization and memory utilization).

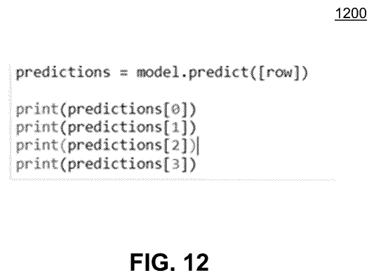

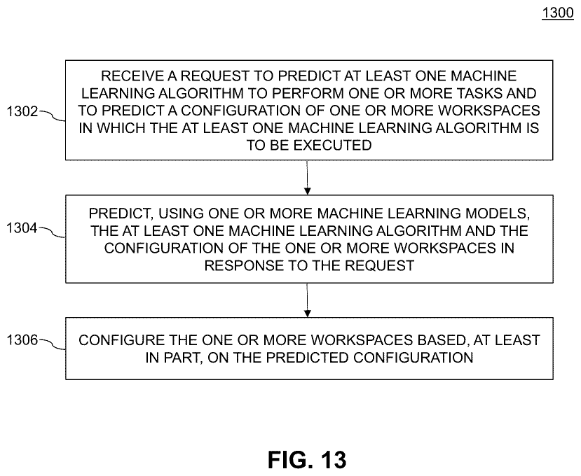

Referring to FIG. 11, which depicts example pseudocode 1100 for compiling and training the generated neural network, an Adam optimization algorithm is used as an optimizer, “categorical crossentrop” is used as a loss function for the classification branch and mean squared error is used as a loss function for regression paths to each target. The model is trained with independent variable data (X_train) and the target variables are passed for each classification and regression path. As shown by the pseudocode 1200 in FIG. 12, the neural network model predicts multiple target values (e.g., machine learning algorithm type, a number of containers, CPU utilization and memory utilization) by passing independent variable values to the predict functions of the model.

According to one or more embodiments, the historical machine learning workspace metrics repository 122/222 and other data repositories or databases referred to herein can be configured according to a relational database management system (RDBMS) (e.g., PostgreSQL). In some embodiments, the historical machine learning workspace metrics repository 122/222 and other data repositories or databases referred to herein are implemented using one or more storage systems or devices associated with the machine learning algorithm recommendation platform 110. In some embodiments, one or more of the storage systems utilized to implement the historical machine learning workspace metrics repository 122/222 and other data repositories or databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the machine learning algorithm recommendation platform 110, the data collection engine 120, ML algorithm type and workspace configuration prediction engine 130 and/or workspace provisioning engine 140 in other embodiments can be implemented at least in part externally to the machine learning algorithm recommendation platform 110, for example, as stand-alone servers, sets of servers or other types of systems coupled to the network 104. For example, the data collection engine 120, ML algorithm type and workspace configuration prediction engine 130 and/or workspace provisioning engine 140 may be provided as cloud services accessible by the machine learning algorithm recommendation platform 110.

The data collection engine 120, ML algorithm type and workspace configuration prediction engine 130 and/or workspace provisioning engine 140 in the FIG. 1 embodiment are each assumed to be implemented using at least one processing device. Each such processing device generally comprises at least one processor and an associated memory, and implements one or more functional modules for controlling certain features of the data collection engine 120, ML algorithm type and workspace configuration prediction engine 130 and/or workspace provisioning engine 140.

At least portions of the machine learning algorithm recommendation platform 110 and the elements thereof may be implemented at least in part in the form of software that is stored in memory and executed by a processor. The machine learning algorithm recommendation platform 110 and the elements thereof comprise further hardware and software required for running the machine learning algorithm recommendation platform 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the data collection engine 120, ML algorithm type and workspace configuration prediction engine 130, workspace provisioning engine 140 and other elements of the machine learning algorithm recommendation platform 110 in the present embodiment are shown as part of the machine learning algorithm recommendation platform 110, at least a portion of the data collection engine 120, ML algorithm type and workspace configuration prediction engine 130, workspace provisioning engine 140 and other elements of the machine learning algorithm recommendation platform 110 in other embodiments may be implemented on one or more other processing platforms that are accessible to the machine learning algorithm recommendation platform 110 over one or more networks. Such elements can each be implemented at least in part within another system element or at least in part utilizing one or more stand-alone elements coupled to the network 104.

It is assumed that the machine learning algorithm recommendation platform 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or LXCs, or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the data collection engine 120, ML algorithm type and workspace configuration prediction engine 130, workspace provisioning engine 140 and other elements of the machine learning algorithm recommendation platform 110, and the elements thereof can each be implemented in the form of one or more LXCs running on one or more VMs. Other arrangements of one or more processing devices of a processing platform can be used to implement the data collection engine 120, ML algorithm type and workspace configuration prediction engine 130 and workspace provisioning engine 140, as well as other elements of the machine learning algorithm recommendation platform 110. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the machine learning algorithm recommendation platform 110 to reside in different data centers. Numerous other distributed implementations of the machine learning algorithm recommendation platform 110 are possible.

Accordingly, one or each of the data collection engine 120, ML algorithm type and workspace configuration prediction engine 130, workspace provisioning engine 140 and other elements of the machine learning algorithm recommendation platform 110 can each be implemented in a distributed manner so as to comprise a plurality of distributed elements implemented on respective ones of a plurality of compute nodes of the machine learning algorithm recommendation platform 110.

It is to be appreciated that these and other features of illustrative embodiments are presented by way of example only, and should not be construed as limiting in any way. Accordingly, different numbers, types and arrangements of system elements such as the data collection engine 120, ML algorithm type and workspace configuration prediction engine 130, workspace provisioning engine 140 and other elements of the machine learning algorithm recommendation platform 110, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the machine learning algorithm recommendation platform can be offered to cloud infrastructure customers or other users as part of FaaS, CaaS and/or PaaS offerings.

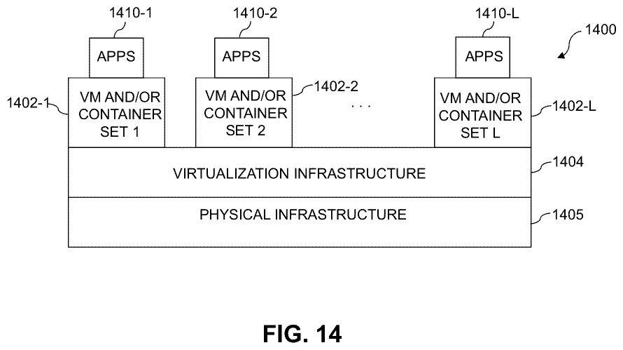

The operation of the information processing system 100 will now be described in further detail with reference to the flow diagram of FIG. 13. With reference to FIG. 13, a process 1300 for machine learning algorithm and workspace configuration prediction as shown includes steps 1302 through 1306, and is suitable for use in the system 100 but is more generally applicable to other types of information processing systems comprising a machine learning algorithm recommendation platform configured for machine learning algorithm and workspace configuration prediction.

In step 1302, a request to predict at least one machine learning algorithm to perform one or more tasks and to predict a configuration of one or more workspaces in which the at least one machine learning algorithm is to be executed is received.

In step 1304, using one or more machine learning models, the at least one machine learning algorithm and the configuration of the one or more workspaces are predicted in response to the request. In illustrative embodiments, the predicted configuration identifies at least one of a number of hosting instances and a size of one or more resources for the one or more workspaces. The hosting instance comprises at least one of a pod, a container and a virtual machine. The size of the one or more resources comprises at least one of an amount of CPU utilization and an amount of memory utilization.

In step 1306, the one or more workspaces are configured based, at least in part, on the predicted configuration. In illustrative embodiments, configuring the one or more workspaces comprises provisioning the identified number of hosting instances and at least one of the one or more resources at the identified size on at least one device. Configuring the one or more workspaces can also comprise loading one or more libraries into the one or more workspaces to enable the at least one machine learning algorithm. The one or more workspaces correspond to one or more host devices.

In illustrative embodiments, the one or more machine learning models are trained with a dataset comprising historical machine learning workspace metrics. The historical machine learning workspace metrics comprise one or more of machine learning type, domain type, training dataset size, feature dimension size, a number of users and usage type for respective ones of a plurality of workspaces. The historical machine learning workspace metrics further comprise an amount of CPU utilization, an amount of memory utilization and an amount of input/output utilization for the respective ones of the plurality of workspaces. One or more independent variable datasets and one or more dependent variable datasets are created from the dataset. The one or more dependent variable datasets correspond to at least one of machine learning algorithm type, a number of containers, CPU utilization and memory utilization for respective ones of a plurality of workspaces.

In illustrative embodiments, the one or more machine learning models comprise a multiple output classification and regression machine learning algorithm. Outputs of the multiple output classification and regression machine learning algorithm comprise a type of the at least one machine learning algorithm, a number of containers, a memory size and a number of CPU core units for the one or more workspaces.

It is to be appreciated that the FIG. 13 process and other features and functionality described above can be adapted for use with other types of information systems configured to execute machine learning algorithm and workspace configuration prediction services in a machine learning algorithm recommendation platform or other type of platform.

The particular processing operations and other system functionality described in conjunction with the flow diagram of FIG. 13 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 13 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a machine learning algorithm recommendation platform as disclosed herein can provide a number of significant advantages relative to conventional arrangements. For example, the machine learning algorithm recommendation platform uses machine learning to predict machine learning algorithms to perform one or more tasks and corresponding workspace configurations. Advantageously, the platform uses the predicted values from the workspace configurations when provisioning new workspace instances.

Technical problems exist with conventional evaluation of machine learning algorithm candidates in that large amounts of compute resources are needed to perform, for example, data engineering, data visualization, training, testing and cross validation of the machine learning algorithm candidates. The complex evaluation process must be repeated each time a proposed machine learning algorithm is evaluated and/or a new objective requiring machine learning is developed, resulting in a lack of cumulative knowledge, a lack of consistency when choosing machine learning algorithms, and a lack of a centralized recommendation point for corporate compliance, artificial intelligence governance and ethics.

Unlike conventional approaches, illustrative embodiments provide technical solutions which formulate programmatically and with a high degree of accuracy, the prediction of the most optimal machine learning algorithm and its corresponding workspace infrastructure for a plurality of inputted features. The embodiments advantageously leverage one or more sophisticated machine learning algorithms and train the machine learning algorithm(s) using historical machine learning workspace metrics corresponding to the same or similar machine learning workspaces as those for which new workspaces need to be created.

As an additional advantage, illustrative embodiments implement a multi-target classification and regression model that is trained using multi-dimensional features of historical machine learning workspace metrics. The model predicts a machine learning algorithm to achieve a given objective, as well as the number of hosting instances and the sizes of resources for new hosting instances, wherein the prediction factors in features such as the type of machine learning needed, dataset sizes, dimensionality, domain, number of users and usage type.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the machine learning algorithm recommendation platform 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a machine learning algorithm recommendation platform in illustrative embodiments. These and other cloud-based systems in illustrative embodiments can include object stores.

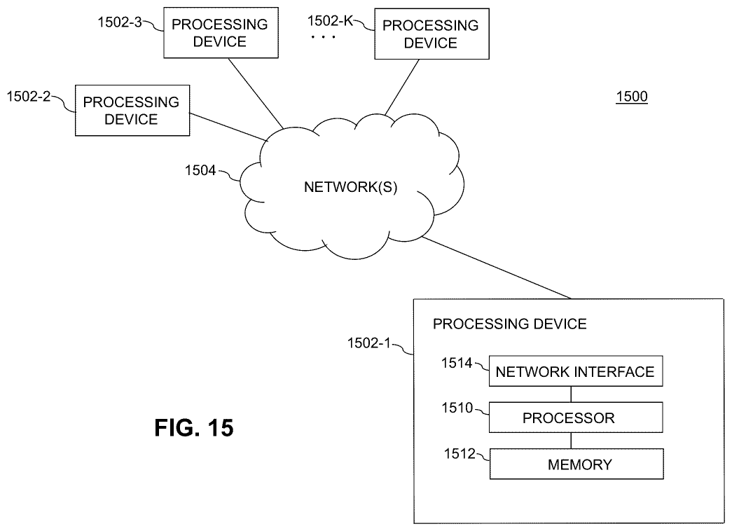

Illustrative embodiments of processing platforms will now be described in greater detail with reference to FIGS. 14 and 15. Although described in the context of system 100, these platforms may also be used to implement at least portions of other information processing systems in other embodiments.

FIG. 14 shows an example processing platform comprising cloud infrastructure 1400. The cloud infrastructure 1400 comprises a combination of physical and virtual processing resources that may be utilized to implement at least a portion of the information processing system 100. The cloud infrastructure 1400 comprises multiple virtual machines (VMs) and/or container sets 1402-1, 1402-2, . . . 1402-L implemented using virtualization infrastructure 1404. The virtualization infrastructure 1404 runs on physical infrastructure 1405, and illustratively comprises one or more hypervisors and/or operating system level virtualization infrastructure. The operating system level virtualization infrastructure illustratively comprises kernel control groups of a Linux operating system or other type of operating system.

The cloud infrastructure 1400 further comprises sets of applications 1410-1, 1410-2, . . . 1410-L running on respective ones of the VMs/container sets 1402-1, 1402-2, . . . 1402-L under the control of the virtualization infrastructure 1404. The VMs/container sets 1402 may comprise respective VMs, respective sets of one or more containers, or respective sets of one or more containers running in VMs.

In some implementations of the FIG. 14 embodiment, the VMs/container sets 1402 comprise respective VMs implemented using virtualization infrastructure 1404 that comprises at least one hypervisor. A hypervisor platform may be used to implement a hypervisor within the virtualization infrastructure 1404, where the hypervisor platform has an associated virtual infrastructure management system. The underlying physical machines may comprise one or more distributed processing platforms that include one or more storage systems.

In other implementations of the FIG. 14 embodiment, the VMs/container sets 1402 comprise respective containers implemented using virtualization infrastructure 1404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1400 shown in FIG. 14 may represent at least a portion of one processing platform. Another example of such a processing platform is processing platform 1500 shown in FIG. 15.

The processing platform 1500 in this embodiment comprises a portion of system 100 and includes a plurality of processing devices, denoted 1502-1, 1502-2, 1502-3, . . . 1502-K, which communicate with one another over a network 1504.

The network 1504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1502-1 in the processing platform 1500 comprises a processor 1510 coupled to a memory 1512. The processor 1510 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1512 may comprise random access memory (RAM), read-only memory (ROM), flash memory or other types of memory, in any combination. The memory 1512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1502-1 is network interface circuitry 1514, which is used to interface the processing device with the network 1504 and other system components, and may comprise conventional transceivers.

The other processing devices 1502 of the processing platform 1500 are assumed to be configured in a manner similar to that shown for processing device 1502-1 in the figure.

Again, the particular processing platform 1500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the machine learning algorithm recommendation platform 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and machine learning algorithm recommendation platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving a request to predict at least one machine learning algorithm to perform one or more tasks and to predict a configuration of one or more workspaces in which the at least one machine learning algorithm is to be executed;
predicting, using one or more machine learning models, the at least one machine learning algorithm and the configuration of the one or more workspaces in response to the request; and
configuring the one or more workspaces based, at least in part, on the predicted configuration;
wherein the steps of the method are executed by at least one processing device operatively coupled to at least one memory.

2. The method of claim 1 wherein the predicted configuration identifies at least one of a number of hosting instances and a size of one or more resources for the one or more workspaces.

3. The method of claim 2 wherein the hosting instances comprise at least one of a pod, a container and a virtual machine.

4. The method of claim 2 wherein the size of the one or more resources comprises at least one of an amount of central processing unit utilization and an amount of memory utilization.

5. The method of claim 2 wherein configuring the one or more workspaces comprises provisioning the identified number of hosting instances and at least one of the one or more resources at the identified size on at least one device.

6. The method of claim 1 wherein configuring the one or more workspaces comprises loading one or more libraries into the one or more workspaces to enable the at least one machine learning algorithm.

7. The method of claim 1 wherein the one or more workspaces correspond to one or more host devices.

8. The method of claim 1 further comprising training the one or more machine learning models with a dataset comprising historical machine learning workspace metrics.

9. The method of claim 8 wherein the historical machine learning workspace metrics comprise one or more of machine learning type, domain type, training dataset size, feature dimension size, a number of users and usage type for respective ones of a plurality of workspaces.

10. The method of claim 9 wherein the historical machine learning workspace metrics further comprise an amount of central processing unit utilization, an amount of memory utilization and an amount of input/output utilization for the respective ones of the plurality of workspaces.

11. The method of claim 8 further comprising creating from the dataset one or more independent variable datasets and one or more dependent variable datasets.

12. The method of claim 11 wherein the one or more dependent variable datasets correspond to at least one of machine learning algorithm type, a number of containers, central processing unit utilization and memory utilization for respective ones of a plurality of workspaces.

13. The method of claim 1 wherein the one or more machine learning models comprise a multiple output classification and regression machine learning algorithm.

14. The method of claim 13 wherein outputs of the multiple output classification and regression machine learning algorithm comprise a type of the at least one machine learning algorithm, a number of containers, a memory size and a number of central processing unit core units for the one or more workspaces.

15. An apparatus comprising:
a processing device operatively coupled to a memory and configured:
to receive a request to predict at least one machine learning algorithm to perform one or more tasks and to predict a configuration of one or more workspaces in which the at least one machine learning algorithm is to be executed;
to predict, using one or more machine learning models, the at least one machine learning algorithm and the configuration of the one or more workspaces in response to the request; and
to configure the one or more workspaces based, at least in part, on the predicted configuration.

16. The apparatus of claim 15 wherein the predicted configuration identifies at least one of a number of hosting instances and a size of one or more resources for the one or more workspaces.

17. The apparatus of claim 16 wherein, in configuring the one or more workspaces, the processing device is configured to provision the identified number of hosting instances and at least one of the one or more resources at the identified size on at least one device.

18. An article of manufacture comprising a non-transitory processor-readable storage medium having stored therein program code of one or more software programs, wherein the program code when executed by at least one processing device causes the at least one processing device to perform the steps of:
receiving a request to predict at least one machine learning algorithm to perform one or more tasks and to predict a configuration of one or more workspaces in which the at least one machine learning algorithm is to be executed;
predicting, using one or more machine learning models, the at least one machine learning algorithm and the configuration of the one or more workspaces in response to the request; and
configuring the one or more workspaces based, at least in part, on the predicted configuration.

19. The article of manufacture of claim 18 wherein the predicted configuration identifies at least one of a number of hosting instances and a size of one or more resources for the one or more workspaces.

20. The article of manufacture of claim 19 wherein, in configuring the one or more workspaces, the program code causes the at least one processing device to provision the identified number of hosting instances and at least one of the one or more resources at the identified size on at least one device.
